(19) United States
(12) Patent Application Publication
(10) Pub. No.: US 2026/0277033 A1
(43) Pub. Date: Sep. 17, 2026

(54) ELECTRONIC DEVICE

(71) Applicant: InnoLux Corporation, Miao-Li County (TW)

(72) Inventor: Chien-Min CHAO, Miao-Li County (TW)

(21) Appl. No.: 19/401,538

(22) Filed: Nov. 26, 2025

(30) Foreign Application Priority Data
Dec. 26, 2024 (CN) 202411937474.9

(51) Int. Cl. G02F 1/01; E06B 9/24; G02F 1/1335; G02F 1/1343; G02F 1/137; H01F 7/06

(52) U.S. Cl. CPC G02F 1/0128; E06B 9/24; G02F 1/133553; G02F 1/13439; G02F 1/137; H01F 7/06; E06B 2009/2464

(57) ABSTRACT

An electronic device includes: a switchable light modulation element including: a light modulation structure including a light modulation layer and an electrode for driving the light modulation layer; and a vibration element disposed adjacent to at least one side of the light modulation structure; wherein the vibration element is used to disturb the light modulation layer when driven, and the vibration element and the electrode are separated by at least one insulating material to electrically insulate each other.

### CROSS-REFERENCE TO RELATED APPLICATIONS

This application claims the benefits of the Chinese Patent Application Serial Number 202411937474.9, filed on Dec. 26, 2024, the subject matter of which is incorporated herein by reference.

### BACKGROUND

### Field

The present disclosure relates to an electronic device. More specifically, the present disclosure relates to an electronic device comprising a switchable light modulation element.

### Description of Related Art

In recent years, with the development of science and technology and the increasing attention paid to environmental protection, various energy-saving and carbon-reducing products have been produced, such as smart windows. Smart windows are windows that can be controlled by electric fields to present different optical states (such as transparent state or color-changing state), thereby changing the light transmittance.

However, there are still many disadvantages in related electronic products, such as slow state conversion process. Therefore, it is desirable to provide a novel electronic device to improve the conventional defects.

### SUMMARY

The present disclosure provides an electronic device, comprising: a switchable light modulation element, comprising: a light modulation structure, comprising a light modulation layer and an electrode for driving the light modulation layer; and a vibration element disposed adjacent to at least one side of the light modulation structure, wherein the vibration element is used to disturb the light modulation layer when driven, and the vibration element and the electrode are separated by at least one insulating material to electrically insulate each other.

Other novel features of the disclosure will become more apparent from the following detailed description when taken in conjunction with the accompanying drawings.

### BRIEF DESCRIPTION OF DRAWINGS

FIG. 1A to FIG. 1C are schematic views of an electronic device according to one embodiment of the present disclosure in different operation states.

FIG. 2A to FIG. 2C are top schematic views of vibration elements according to different embodiments of the present disclosure.

FIG. 3 is a schematic view of an electronic device according to one embodiment of the present disclosure.

FIG. 4A and FIG. 4B are schematic views of an electronic device according to one embodiment of the present disclosure in operation.

FIG. 5A and FIG. 5B are schematic views of an electronic device according to one embodiment of the present disclosure in operation.

FIG. 6 is a schematic view of an electronic device according to one embodiment of the present disclosure.

FIG. 7 is a schematic view of an electronic device according to one embodiment of the present disclosure.

FIG. 8 is a schematic view of an electronic device according to one embodiment of the present disclosure.

FIG. 9A and FIG. 9B are schematic views of an electronic device according to one embodiment of the present disclosure in operation.

FIG. 10A to FIG. 10C are schematic views showing the manufacture of an electronic device according to one embodiment of the present disclosure.

FIG. 11A to FIG. 11C are schematic views showing the manufacture of an electronic device according to one embodiment of the present disclosure.

FIG. 12A to FIG. 12C are schematic views showing the manufacture of an electronic device according to one embodiment of the present disclosure.

### DETAILED DESCRIPTION

The following is specific embodiments to illustrate the implementation of the present disclosure. Those who are familiar with this technique can easily understand the other advantages and effects of the present disclosure from the content disclosed in the present specification. The present disclosure can also be implemented or applied by other different specific embodiments, and various details in the present specification can also be modified and changed according to different viewpoints and applications without departing from the spirit of the present disclosure.

It should be noted that, in the present specification, when a component is described to have an element, it means that the component may have one or more of the elements, and it does not mean that the component has only one of the element, except otherwise specified. Furthermore, the ordinals recited in the specification and the claims such as “first”, “second” and so on are intended only to describe the elements claimed and imply or represent neither that the claimed elements have any proceeding ordinals, nor that sequence between one claimed element and another claimed element or between steps of a manufacturing method. The use of these ordinals is merely to differentiate one claimed element having a certain designation from another claimed element having the same designation.

In the specification and the appended claims of the present disclosure, certain words are used to refer to specific elements. Those skilled in the art should understand that electronic device manufacturers may refer to the same components by different names. The present specification does not intend to distinguish between elements that have the same function but have different names. In the following description and claims, words such as “comprising”, “including”, “containing”, and “having” are open-ended words, so they should be interpreted as meaning “containing but not limited to . . . ”. Therefore, when the terms “comprising”, “including”, “containing” and/or “having” are used in the description of the present disclosure, they specify the existence of corresponding features, regions, steps, operations and/or components, but do not exclude the existence of one or more corresponding features, regions, steps, operations and/or components.

The terms, such as “about”, “substantially”, or “approximately”, are generally interpreted as within 10%, 5%, 3%, 2%, 1%, or 0.5% of a given value or range. The quantity given here is an approximate quantity, that is, without specifying “about”, “approximately”, “substantially” and “approximately”, “about”, “approximately”, “substantially” and “approximately” can still be implied. Furthermore, when a value is “in a range from a first value to a second value” or “in a range between a first value and a second value”, the value can be the first value, the second value, or another value between the first value and the second value.

In the present specification, except otherwise specified, the terms (including technical and scientific terms) used herein have the meanings generally known by a person skilled in the art. It should be noted that, except otherwise specified, in the embodiments of the present disclosure, these terms (for example, the terms defined in the generally used dictionary) should have the meanings identical to those known in the art, the background of the present disclosure or the context of the present specification, and should not be read by an ideal or over-formal way.

In addition, relative terms such as “below” or “under” and “on”, “above” or “over” may be used in the embodiments to describe the relative relationship between one element and another element in the drawings. It will be understood that if the device in the drawing was turned upside down, elements described on the “lower” side would then become elements described on the “upper” side. When a unit (for example, a layer or a region) is referred to as being “on” another unit, it can be directly on the another unit or there may be other units therebetween. Furthermore, when a unit is said to be “directly on another unit”, there is no unit therebetween. Moreover, when a unit is said to be “on another unit”, the two have a top-down relationship in a top view, and the unit can be disposed above or below the another unit, and the top-bottom relationship depends on the orientation of the device.

In the present disclosure, the thickness, the length, the width, or the distance and angle between elements may be measured by using an optical microscope (OM), scanning electron microscope (SEM), film thickness profiler (α-step), ellipsometer, or other suitable methods. More specifically, according to some embodiments, a scanning electron microscope can be used to obtain a cross-sectional image of the structure and measure the thickness, length, width of each element or the distance and angle between elements. Furthermore, any two values or directions used for comparison may have a certain error. If the first value is equal to the second value, it implies that there may be an error of about 10% between the first value and the second value. If the first direction is perpendicular to the second direction, the angle between the first direction and the second direction may be between 80° and 100°. If the first direction is parallel to the second direction, the angle between the first direction and the second direction may be between 0° and 10°.

The embodiments of the present disclosure can be understood in conjunction with the drawings, and the drawings of the present disclosure are also considered as a part of the disclosure. It should be understood that the drawings of the present disclosure are not drawn to scale, and in fact, the sizes of elements may be arbitrarily enlarged or reduced in order to clearly illustrate the features of the present disclosure.

It should be noted that the technical solutions provided in the following different embodiments can be replaced, combined or mixed with each other to form another embodiment without violating the spirit of the present disclosure.

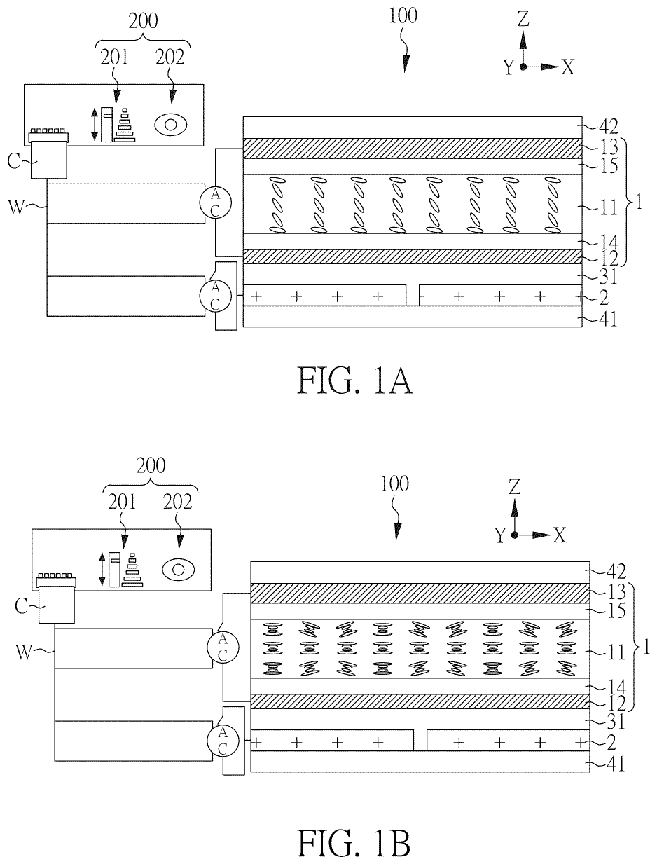

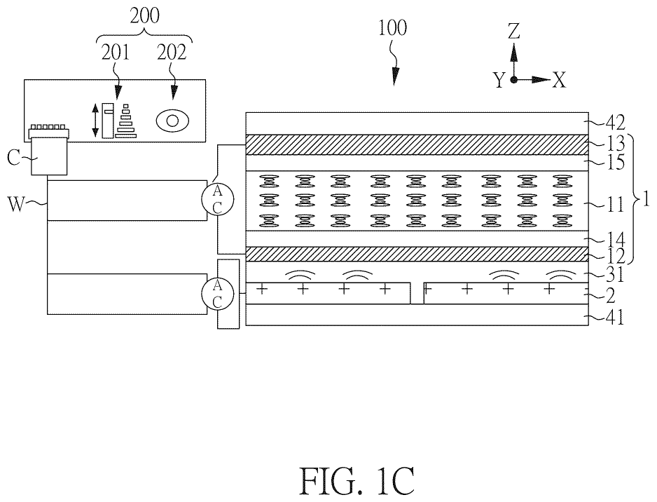

FIG. 1A to FIG. 1C are schematic views of an electronic device according to one embodiment of the present disclosure in different operation states.

In one embodiment of the present disclosure, as shown in FIG. 1A, the electronic device comprises a switchable light modulation element 100. The switchable light modulation element 100 may comprise: a light modulation structure 1, comprising a light modulation layer 11 and an electrode used for driving the light modulation layer (for example, a first electrode 12); and a vibration element 2 disposed adjacent to at least one side of the light modulation structure 1. Herein, the vibration element 2 is used to disturb the light modulation layer 11 when driven, and the vibration element 2 and the electrode (for example, the first electrode 12) are separated by at least one insulating material to electrically insulate each other. For example, as shown in FIG. 1A, the switchable light modulation element 100 may comprise an insulating layer 31 disposed between the vibration element 2 and the first electrode 12, so the vibration element 2 and the first electrode 12 are electrically insulated from each other; but the present disclosure is not limited thereto.

In the present disclosure, the light modulation layer 11 may comprise a dye liquid crystal, an electrochromic material, suspended particles or a combination thereof, but the present disclosure is not limited thereto. Suitable liquid crystal material may comprises twisted nematic liquid crystals (TNs), high twisted nematic liquid crystals (HTNs), polymer network liquid crystals (PNLCls), polymer dispersed liquid crystals (PDLCs), cholesteric liquid crystals (CHLCs), polymer stabilized cholesteric texture (PSCT), other suitable material or a combination thereof, but the present disclosure is not limited thereto. In the present disclosure, the material of the first electrode 12 may comprise a transparent conductive material, and for example, may comprise indium zinc oxide (IZO), indium tin oxide (ITO), indium tin zinc oxide (ITZO), indium gallium zinc oxide (IGZO), aluminum zinc oxide (AZO) or a combination thereof, but the present disclosure is not limited thereto. In the present disclosure, the material of the insulating layer 31 may comprise silicon oxide, silicon nitride, silicon oxynitride, other suitable material or a combination thereof, but the present disclosure is not limited thereto.

In the present disclosure, the vibration element 2 may comprise at least one piezoelectric material. Suitable piezoelectric material may comprise, for example, zinc oxide (ZnO), lead zirconate titanate (PZT), aluminum nitride (AlN), lithium niobate (LiNbO₃), barium titanate (BaTiO₃), or a combination thereof, but the present disclosure is not limited thereto. In the present disclosure, for example, the vibration element 2 may disturb the light modulation layer 11 at a frequency, which may be greater than 0 Hz. For example, the frequency may be greater than 0 Hz and less than or equal to 1000 Hz (that is, 0 Hz<frequency≤1000 Hz), greater than or equal to 100 Hz and less than or equal to 900 Hz (that is, 100 Hz≤frequency≤900 Hz), greater than or equal to 200 Hz and less than or equal to 800 Hz (that is, 200 Hz≤frequency≤800 Hz), greater than or equal to 300 Hz and less than or equal to 700 Hz (that is, 300 Hz≤frequency≤700 Hz), or greater than or equal to 400 Hz and less than or equal to 600 Hz (that is, 400 Hz≤frequency≤600 Hz), but the present disclosure is not limited thereto. In one embodiment of the present disclosure, the vibration element 2 can be designed for the entire surface, but the present disclosure is not limited thereto. In other embodiments, the vibration element 2 can be patterned.

In one embodiment of the present disclosure, as shown in FIG. 1A, the switchable light modulation element 100 may further comprise: a first substrate 41; and a second substrate 42 disposed on a side of the first substrate 41, wherein the light modulation structure 1 and the vibration element 2 are disposed between the first substrate 41 and the second substrate 42. More specifically, the vibration element 2 may be disposed on a side of the first substrate 41 adjacent to the second substrate 42, and the vibration element 2 is disposed between the first substrate 41 and the first electrode 12.

In the present disclosure, the materials of the first substrate 41 and the second substrate 42 may respectively comprise glass, quartz, sapphire, ceramics, plastics, polycarbonate (PC), polyimide (PI), polypropylene (PP), polyethylene terephthalate (PET), polymethylmethacrylate (PMMA), other suitable substrate material or a combination thereof, but the present disclosure is not limited thereto.

In one embodiment of the present disclosure, as shown in FIG. 1A, the light modulation structure 1 may further comprise a second electrode 13 disposed between the light modulation layer 11 and the second substrate 42, wherein the light modulation layer 11 is disposed between the first electrode 12 and the second electrode 13. By applying voltages to the first electrode 12 and the second electrode 13, an electric field is generated between the first electrode 12 and the second electrode 13 to control the light modulation layer 11, thereby switching the switchable light modulation element 100 between the transparent state and the color-changing state (for example, the dark state or the black state). In the present disclosure, the material of the second electrode 13 may be the same as or different from that of the first electrode 12, and suitable material of the second electrode 13 may be as that of the first electrode 12 and is not described again here.

In one embodiment of the present disclosure, when the light modulation layer 11 comprises a liquid crystal material, as shown in FIG. 1A, the light modulation structure 1 may further comprise: a first alignment layer 14 disposed between the first electrode 12 and the light modulation layer 11; and a second alignment layer 15 disposed between the second electrode 13 and the light modulation layer 11. The first alignment layer 14 and the second alignment layer 15 can make the liquid crystal material in the light modulation layer 11 align in a certain direction approximately.

The following will describe in detail the electronic device of one embodiment of the present disclosure in different operation states. Herein, the light modulation layer 11 in FIG. 1A to FIG. 1C is exemplified by highly twisted nematic liquid crystal, but the present disclosure is not limited thereto.

In one embodiment of the present disclosure, when voltages are applied to the first electrode 12 and the second electrode 13, as shown in FIG. 1A, the long axis of most of the liquid crystal material in the light modulation layer 11 can be arranged, for example, substantially perpendicular to the surface of the first substrate 41 (or the surface of the second substrate 42), so that most of the incident light can pass through the light modulation layer 11, making the switchable light modulation element 100 present a transparent state.

When the voltage applied to the first electrode 12 and the second electrode 13 is removed (that is, no voltage is applied to the first electrode 12 and the second electrode 13), as shown in FIG. 1B, the liquid crystal material in the light modulation layer 11 will gradually return to its initial state. At this time, the liquid crystal material is restored to its initial state only by the force of the alignment layer (such as the first alignment layer 14 and/or the second alignment layer 15). Since the force of the alignment layer (such as the first alignment layer 14 and/or the second alignment layer 15) cannot completely control the rotation direction of the liquid crystal material, the switchable light modulation element 100 will temporarily present a foggy state before most of the liquid crystal material returns to its initial state.

In the present disclosure, for example, the vibration element 2 may be activated when the voltage applied to the first electrode 12 and the second electrode 13 is removed (for example, before, at the same time as, or after the voltage is removed). As shown in FIG. 1C, by applying a voltage to the vibration element 2, the vibration element 2 is vibrated at a frequency and disturbs the light modulation layer 11, the speed at which the liquid crystal material returns to its initial state can be accelerated, thereby accelerating the switching of the switchable light modulation element 100 from a transparent state to a dark state (or a black state). Thus, the electronic device of one embodiment of the present disclosure can quickly switch between a transparent state and a color-changing state and can be applied to smart windows or car sunroofs, but the present disclosure is not limited thereto.

In the present disclosure, the switchable light modulation element 100 may be controlled by a microcomputer, but the present disclosure is not limited thereto. In other embodiments, the switchable light modulation element 100 may also be controlled by manual operation. For example, as shown in FIG. 1A to FIG. 1C, the electronic device may further comprise a control system 200, which may selectively comprise a dimming system 201 and/or a vibration system 202. The control system 200 may be electrically connected to the light modulation structure 1 and/or the vibration element 2 through a circuit board C and a conductive wire W, thereby controlling the switchable light modulation element 100. The dimming system 201 may be, for example, a dimming button. By turning the dimming button, the electric field strength applied to the light modulation structure 1 can be adjusted, so that the light modulation layer 11 presents different levels of the transparent state or the dark state according to the electric field strength. The vibration system 202 may be, for example, a button. By pressing the button to drive the vibration element 2, the vibration of the vibration element 2 disturbs the light modulation layer 11, so that the material of the light modulation layer 11 quickly and evenly reaches a stable state. The above is only an example, and the switchable light modulation element 100 and the vibration element 2 may be controlled by other methods. In one embodiment of the present disclosure, another vibration element (not shown in the figure) may be selectively disposed between the second substrate 42 and the second electrode 13, and another vibration element and the second electrode 13 may be separated by at least one insulating material (not shown in the figure) to electrically insulate each other. Another vibration element may vibrate at a frequency and disturb the light modulation layer 11, thereby accelerating the material of the light modulation layer 11 reach a uniform and stable state. In addition, another vibration element may be driven by the vibration system 202.

In the present disclosure, the material of another vibration element may be the same as or different from that of the vibration element, and the material of another vibration element is as the material of the vibration element and is not described again here. In the present disclosure, the vibration frequency of another vibration element may be the same as or different from that of the vibration element. The vibration frequency of another vibration element may be greater than 0 Hz and less than or equal to 1000 Hz (that is, 0 Hz<frequency≤1000 Hz), but the present disclosure is not limited thereto.

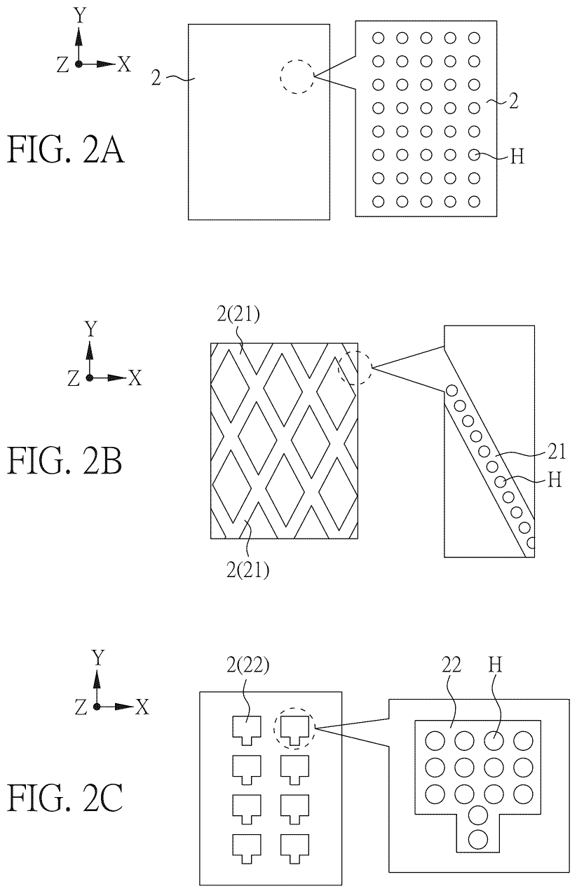

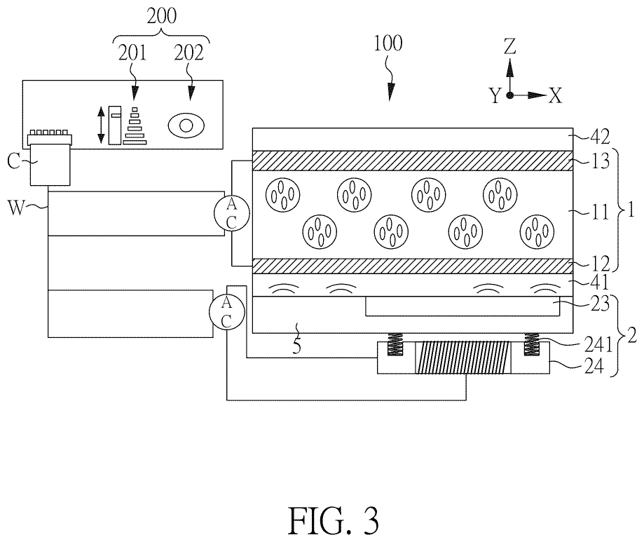

FIG. 2A to FIG. 2C are top schematic views of vibration elements according to different embodiments of the present disclosure.

In one embodiment of the present disclosure, as shown in FIG. 2A, when observing from the top view direction Z, the vibration element 2 may be a whole-surface film, and in one embodiment, the vibration element 2 of the whole-surface film may selectively include a plurality of holes H. The holes H may improve the light transmittance and/or vibration transmission efficiency of the vibration element 2, thereby improving the light transmittance of the switchable light modulation element 100 (for example, as shown in FIG. 1A) and/or the switching speed of the switchable light modulation element 100 (for example, as shown in FIG. 1A) between the transparent state and the color-changing state.

In one embodiment of the present disclosure, as shown in FIG. 2B, when observing from the top view direction Z, the vibration element 2 may be a patterned film. For example, the vibration element 2 may be of a mesh design, that is, the vibration element 2 may include a plurality of strip structures 21 arranged crosswise with each other. In one embodiment, the strip structures 21 may selectively comprise a plurality of holes H. The holes H can improve the light transmittance and/or vibration transmission efficiency of the vibration element 2, thereby improving the light transmittance of the switchable light modulation element 100 (for example, as shown in FIG. 1A) and/or the switching speed of the switchable light modulation element 100 (for example, as shown in FIG. 1A) between the transparent state and the color-changing state. In the present disclosure, in the top view direction of the electronic device (for example, the Z direction), the area of the vibration element 2 may be less than the area of the switchable light modulation element 100 (for example, as shown in FIG. 1A).

In one embodiment of the present disclosure, as shown in FIG. 2C, when observing from the top view direction Z, the vibration element 2 may be a patterned film. For example, the vibration element 2 may be designed in a block shape, that is, the vibration element 2 may include a plurality of block structures 22. In one embodiment, the block structures may selectively comprise a plurality of holes H. The holes H may improve the light transmittance and/or vibration transmission efficiency of the vibration element 2, thereby improving the light transmittance of the switchable light modulation element 100 (for example, as shown in FIG. 1A) and/or the switching speed of the switchable light modulation element 100 (for example, as shown in FIG. 1A) between the transparent state and the color-changing state. In the present disclosure, in the top view direction of the electronic device (for example, the Z direction), the area of the vibration element 2 may be less than the area of the switchable light modulation element 100 (for example, as shown in FIG. 1A).

In the present disclosure, the shape of the block structures 22 is not particularly limited, for example, it can be circular, elliptical, rectangular, trapezoidal, triangular, other irregular shapes or as shown in FIG. 2C. In addition, the arrangement of the block structures 22 is not particularly limited, and for example, may be arranged in an array or randomly.

FIG. 3 is a schematic view of an electronic device according to one embodiment of the present disclosure. The electronic device of FIG. 3 is similar to that of FIG. 1A, except for the following differences.

In one embodiment of the present disclosure, as shown in FIG. 3, the switchable light modulation element 100 may comprise: a first substrate 41; and a second substrate 42 disposed on a side of the first substrate 41, wherein the light modulation structure 1 is disposed between the first substrate 41 and the second substrate 42, and the vibration element 2 is disposed on a side of one of the first substrate 41 and the second substrate 42 away from the light modulation structure 1. For example, as shown in FIG. 3, the vibration element 2 may be disposed on a side of the first substrate 41 away from the light modulation structure 1, wherein the vibration element 2 may comprise a ferromagnetic material 23 and an electromagnet 24, and the ferromagnetic material 23 is disposed between the first substrate 41 and the electromagnet 24. In one embodiment of the present disclosure, as shown in FIG. 3, the vibration element 2 and the first electrode 12 may be separated by a first substrate 41 to electrically insulate each other, but the present disclosure is not limited thereto. In the top view direction Z of the electronic device, the ferromagnetic material 23 and the electromagnet 24 are overlapped. In the top view direction Z of the electronic device, the ferromagnetic material 23 and/or the electromagnet 24 may be overlapped with a part of the light modulation layer 11. It should be noted that, even not shown in the figure, the ferromagnetic material 23 and/or the electromagnet 24 may be overlapped with most of the light modulation layer 11, but the present disclosure is not limited thereto. When observing from the top view direction Z of the electronic device, the overlapping area of the ferromagnetic material 23 and/or the electromagnet 24 with the light modulation layer 11 may be, for example, within 40%, or even within 35%, 30%, 25%, 20% or 15% of the area of the light modulation layer 11. In other embodiments (not shown in the figure), in the top view direction Z of the electronic device, the ferromagnetic material 23 and/or the electromagnet 24 may not be overlapped with the light modulation layer 11.

In one embodiment of the present disclosure, as shown in FIG. 3, the switchable light modulation element 100 may further comprise a barrier layer 5 (or an insulating layer) disposed between the ferromagnetic material 23 and the electromagnet 24 to separate them from each other. The barrier layer 5 may cover the ferromagnetic material 23 to reduce the contact between the ferromagnetic material 23 and the outside air or moisture, thereby reducing the risk of deterioration of the ferromagnetic material 23.

When driving the vibration element 2, different currents can be applied to the electromagnet 24 to switch the polarity of the electromagnet 24, so that the electromagnet 24 moves toward the ferromagnetic material 23 in an attractive or repulsive manner, thereby disturbing the light modulation layer 11, but the present disclosure is not limited thereto. More specifically, when the electromagnet 24 and the ferromagnetic material 23 attract each other, the electromagnetic 24 can approach the ferromagnetic material 23 through the spring structure 241 and achieve the effect of disturbing the light modulation layer 11 by, for example, hitting the light modulation structure 1. When the electromagnet 24 and the ferromagnetic material 23 repel each other, the electromagnet 24 can move away from the ferromagnetic material 23 through the spring structure 241. In the present disclosure, the electromagnet 24 may hit the light modulation structure 1 at a frequency, which may be greater than 0 Hz. For example, the frequency may be greater than 0 Hz and less than or equal to 1000 Hz (that is, 0 Hz<frequency≤1000 Hz), greater than or equal to 100 Hz and less than or equal to 900 Hz (that is, 100 Hz≤frequency≤900 Hz), greater than or equal to 200 Hz and less than or equal to 800 Hz (that is, 200 Hz≤frequency≤800 Hz), greater than or equal to 300 Hz and less than or equal to 700 Hz (that is, 300 Hz≤frequency≤700 Hz), or greater than or equal to 400 Hz and less than or equal to 600 Hz (that is, 400 Hz≤frequency≤600 Hz), but the present disclosure is not limited thereto.

In the present disclosure, the ferromagnetic material 23 may comprise iron (Fe), cobalt (Co), nickel (Ni), boron (B), RuNF, FeB, FePt, NiFe, CoFe, CoFeB, CoFeBW, CoFeTa, CoPt, CoPd, CoFeNi, PtMn, IrMn, RhMn, FeMn, OsMn, an alloy thereof or a combination thereof, but the present disclosure is not limited thereto. In the present disclosure, the material of the barrier layer 5 may comprise silicon oxide, silicon nitride, silicon oxynitride, glass glue, optical glue, silicon glue, hot melt glue, AB glue, light curing glue, polymer glue, resin, poly-para-xylylene (parylene) or a combination thereof, but the present disclosure is not limited thereto.

In one embodiment of the present disclosure, another vibration element (not shown in the figure) may be selectively disposed on a side of the second substrate 42 away from the light modulation structure 1, and another vibration element may comprise another ferromagnetic material (not shown in the figure) and another electromagnet (not shown in the figure). Another barrier layer (not shown in the figure) may be included between another ferromagnetic material and another electromagnet, thereby reducing the contact between another ferromagnetic material and external air or moisture, thereby reducing the risk of degradation of another ferromagnetic material. In addition, another vibration element may be driven by the vibration system 202. When driving another vibration element, another electromagnet may move away from or towards another ferromagnetic material through a spring structure (not shown in the figure) and, for example, hit the light modulation structure 1 at a frequency to disturb the light modulation layer 11, thereby accelerating the material of the light modulation layer 11 to reach a uniform stable state.

In the present disclosure, another electromagnet may be the same as or different from the electromagnet 24, another ferromagnetic material may be the same as or different from the ferromagnetic material 23, and another ferromagnetic material may be as that of the ferromagnetic material 23 and is not described again here. In the present disclosure, the vibration frequency of another electromagnet may be the same or different from the electromagnet 24, which may be greater than 0 Hz and less than or equal to 1000 Hz (that is, 0 Hz<frequency≤1000 Hz), but the present disclosure is not limited thereto. In the top view direction Z of the electronic device, another electromagnet and the electromagnet 24 may be overlapped or not overlapped. In the top view direction Z of the electronic device, the size of another electromagnet may be the same as or different from the size of the electromagnet 24.

In the present disclosure, the light modulation layer 11 in FIG. 3 is illustrated by suspended particles, but the present disclosure is not limited thereto. The light modulation layer 11 may also be formed using a liquid crystal material such as that shown in FIG. 1A or other suitable materials. In addition, the other components and materials of the electronic device are as described above and will not be described in detail here.

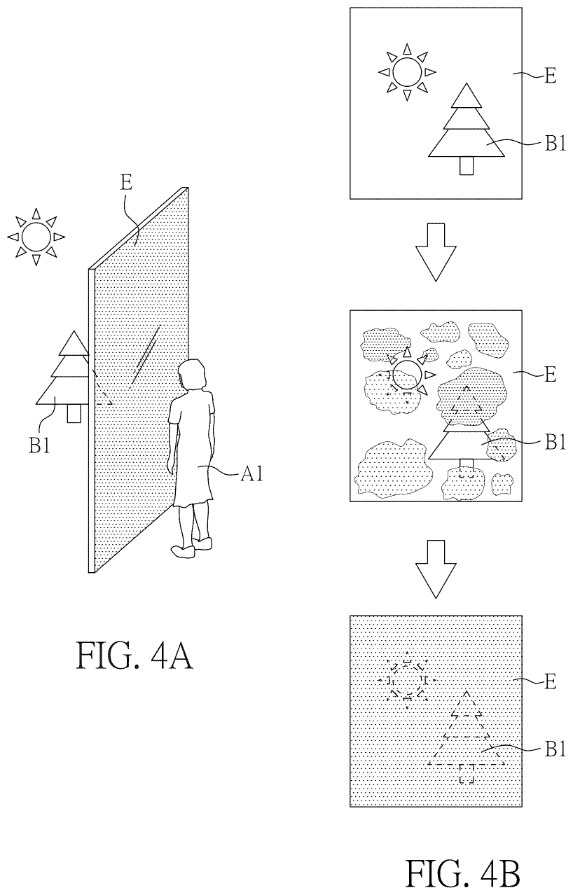

FIG. 4A and FIG. 4B are schematic views of an electronic device according to one embodiment of the present disclosure in operation. Herein, the detailed structure of the electronic device E in FIG. 4A and FIG. 4B may be as shown in FIG. 1A or FIG. 3.

In one embodiment of the present disclosure, the electronic device E may be, for example, a smart window or a passenger window (for example, a car sunroof, but not limited thereto). The electronic device E may comprise the switchable light modulation element 100 and the control system 200 shown in FIG. 1A or FIG. 3, wherein the light modulation layer 11 may comprise an electrochromic material. As shown in FIG. 4A, the user A1 and the object B1 are respectively disposed on two sides of the electronic device E. When the user A1 observes the object B1 from one side of the electronic device E to the other side of the electronic device E, the field of view can be shown in FIG. 4B.

Please refer to FIG. 1A, FIG. 3, FIG. 4A and FIG. 4B. When no voltage is applied to the light modulation structure 1, the light transmittance of the electronic device E may be, for example, greater than or equal to 75%, 80% or 85%. At this time, the electronic device E is in a transparent state, so that the object B1 disposed on the other side of the electronic device E can be clearly observed in the field of vision. When a voltage is applied to the light modulation structure 1, due to the slow response speed and/or uneven color change speed of the electrochromic material, the light transmittance of a part of the electronic device E may be, for example, less than or equal to 25%, 20% or 15%, while the light transmittance of a part of the electronic device E may be, for example, greater than or equal to 75%, 80% or 85%. At this time, the electronic device E is in a transition state (i.e., a part of the electronic device E is in a transparent state and a part of the electronic device E is in a color-changing state). When a voltage is applied to the light modulation structure 1 for a period of time, the light transmittance of the electronic device E may be, for example, less than or equal to 25%, 20% or 15%. At this time, the electronic device E presents a color-changing state (for example, a black state), and therefore, the object B1 disposed on the other side of the electronic device E cannot be clearly observed in the field of vision. The above situation, that the electronic device E is in a transparent state when no voltage is applied to the light modulation structure 1, and the electronic device E is in a color-changing state (for example, a black state) when a voltage is applied to the light modulation structure 1 for a period of time, is for example only, which may be differed according to the type, arrangement or orientation of the light modulation layer 11 in other embodiments. For example, when no voltage is applied to light modulation structure 1, the electronic device E presents a color-changing state (for example, a black state); and when voltage is applied to light modulation structure 1 for a period of time, the electronic device E presents a transparent state.

In the present disclosure, when a voltage is applied to the light modulation structure 1, the vibration element 2 can be driven, and the vibration element 2 can be used to disturb the light modulation layer 11, so that the time of the electronic device E in the transition state can be shortened, and the state switching of the electronic device E can be accelerated. On the contrary, if the vibration element 2 is not driven during the process of applying voltage to the light modulation structure 1, the electronic device E will slowly switch from the transparent state to the color-changing state, affecting the field of vision of the user A1. In one embodiment, when the electronic device E presents a color-changing state, the vibration element 2 may be stopped from being driven.

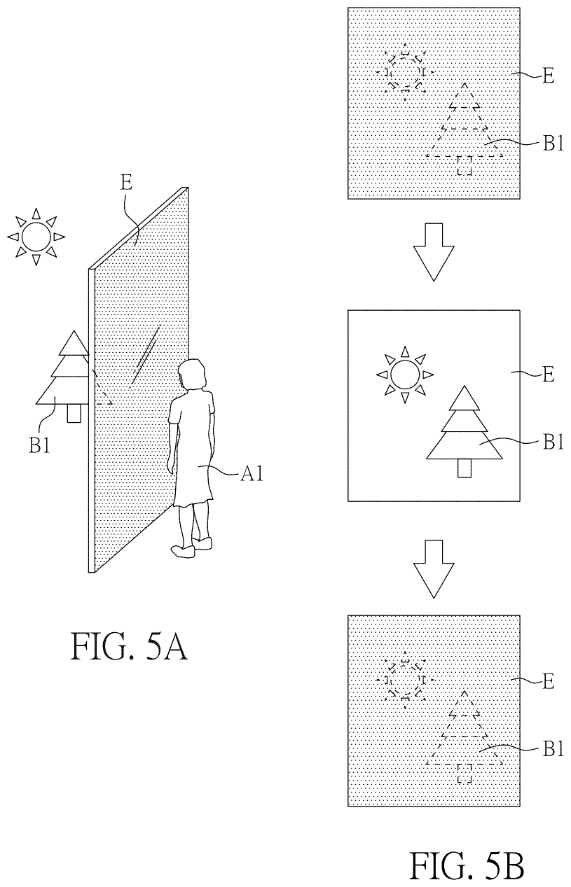

FIG. 5A and FIG. 5B are schematic views of an electronic device according to one embodiment of the present disclosure in operation. Herein, the detailed structure of the electronic device E in FIG. 5A and FIG. 5B may be as shown in FIG. 1A or FIG. 3.

In one embodiment of the present disclosure, the electronic device E may be, for example, a smart window or a passenger window (such as a car sunroof, but not limited thereto). The electronic device E may include a switchable light modulation element 100 and a control system 200 as shown in FIG. 1A or FIG. 3, wherein the light modulation layer 11 may include a dye liquid crystal (comprising a dye and a liquid crystal material). As shown in FIG. 5A, the user A1 and the object B1 are respectively disposed on two sides of the electronic device E. When the user A1 observes the object B1 from one side of electronic device E to the other side of electronic device E, the field of view may be as shown in FIG. 5B.

Please refer to FIG. 1A, FIG. 3, FIG. 5A and FIG. 5B. When no voltage is applied to the light modulation structure 1, the light transmittance of the electronic device E may be, for example, less than or equal to 25%, 20% or 15%. At this time, the electronic device E is in a color-changing state (for example, a black state), and therefore, the object B1 disposed on the other side of the electronic device E cannot be clearly observed in the field of vision. When a voltage is applied to the light modulation structure 1, the light transmittance of the electronic device E may be, for example, greater than or equal to 75%, 80% or 85%. At this time, the electronic device E is in a transparent state, so that the object B1 disposed on the other side of the electronic device E can be clearly observed in the field of vision. After removing the voltage applied to the light modulation structure 1, the dye liquid crystal in the light modulation layer 11 gradually returns to the initial state, so that the electronic device E presents a color-changing state (for example, a black state).

In the present disclosure, the vibration element 2 can be driven during the process of applying a voltage to the light modulation structure 1 and removing the voltage applied to the light modulation structure 1. The vibration element 2 can be used to disturb the light modulation layer 11, so that the state switching of the electronic device E can be accelerated. On the contrary, if the vibration element 2 is not driven during the process of applying voltage to the light modulation structure 1, the speed of switching the electronic device E from the color-changing state to the transparent state will be reduced. If the vibration element 2 is not driven during the process of removing the voltage applied to the light modulation structure 1, the dye liquid crystal can only be restored to the initial state by the force of the alignment layer (such as the first alignment layer 14 and/or the second alignment layer 15), which may easily cause serious fogging of the electronic device E during the state switching process, thereby affecting the field of vision of the user A1. In one embodiment, when the electronic device E is in a transparent state and/or color-changing state, the vibration element 2 can be stopped from being driven.

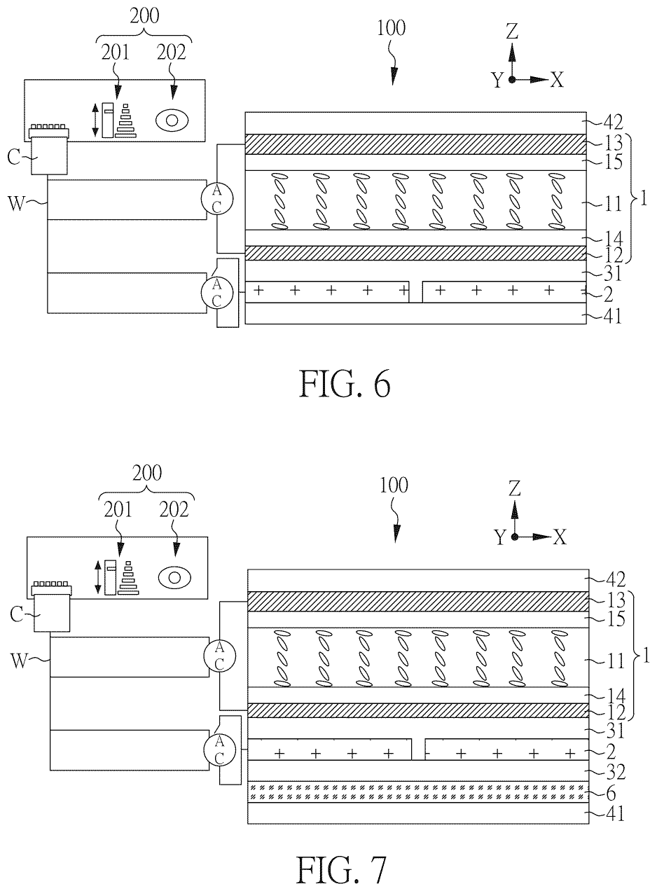

FIG. 6 is a schematic view of an electronic device according to one embodiment of the present disclosure. Herein, the electronic device of FIG. 6 is similar to that of FIG. 1A, except for the following differences.

In one embodiment of the present disclosure, as shown in FIG. 6, the material of the first electrode 12 may be a reflective material, and for example, may comprise a metal, an alloy thereof or a combination thereof. Suitable metal may be, for example, aluminum, chrome, silver or a combination thereof, but the present disclosure is not limited thereto. The first electrode 12 may be used as a reflective element to reflect incident light. Thus, in one embodiment of the present disclosure, the electronic device can be applied to reflectors or rear-view mirrors electronic device, but the present disclosure is not limited thereto.

In one embodiment of the present disclosure, even not shown in the figure, when the first electrode 12 is not used as a reflective element, the switchable light modulation element 100 may further comprise: a reflective element disposed between the first electrode 12 and the vibration element 2; and an insulating layer disposed between the first electrode 12 and the reflective element. The reflective element may be used to reflect incident light.

In one embodiment of the present disclosure, even not shown in the figure, the vibration element 2 shown in FIG. 6 may also comprise the ferromagnetic material 23 and the electromagnet 24 shown in FIG. 3, which are not described again here.

In the present disclosure, the light modulation layer 11 in FIG. 6 is exemplified by a highly twisted nematic liquid crystal, but the present disclosure is not limited thereto, and other suitable materials may also be used to form the light modulation layer 11. In addition, the other elements and materials of the electronic device may be as described above and will not be described in detail here.

FIG. 7 is a schematic view of an electronic device according to one embodiment of the present disclosure. The electronic device shown in FIG. 7 is similar to that shown in FIG. 1A, except for the following differences.

In one embodiment of the present disclosure, as shown in FIG. 7, the switchable light modulation element 100 may further comprise: a reflective element 6 disposed on a side of the first substrate 41 adjacent to the second substrate 42; and an insulating layer 32 disposed between the vibration element 2 and the reflective element 6 (which may be conductive reflective material or non-conductive reflective material). Herein, the light modulation structure 1 and the reflective element 6 are disposed between the first substrate 41 and the second substrate 42, and the light modulation structure 1 is disposed between the second substrate 42 and the reflective element 6. The reflective element 6 may be used to reflect incident light. Thus, in one embodiment of the present disclosure, the electronic device may be applied to reflectors or rear-view mirrors, but the present disclosure is not limited thereto.

In one embodiment of the present disclosure, even not shown in the figure, the vibration element 2 in FIG. 7 may also comprise the ferromagnetic material 23 and the electromagnet 24 shown in FIG. 3, which are not described again here.

In the present disclosure, the material of the reflective element 6 may comprise, for example, a metal, an alloy thereof or a combination thereof. Suitable metal may be, for example, aluminum, chrome, silver or a combination thereof, but the present disclosure is not limited thereto. In the present disclosure, the light modulation layer 11 in FIG. 7 is exemplified by a highly twisted nematic liquid crystal, but the present disclosure is not limited thereto, and other suitable materials may also be used to form the light modulation layer 11. In addition, the other elements and materials of the electronic device may be as described above and will not be described in detail here.

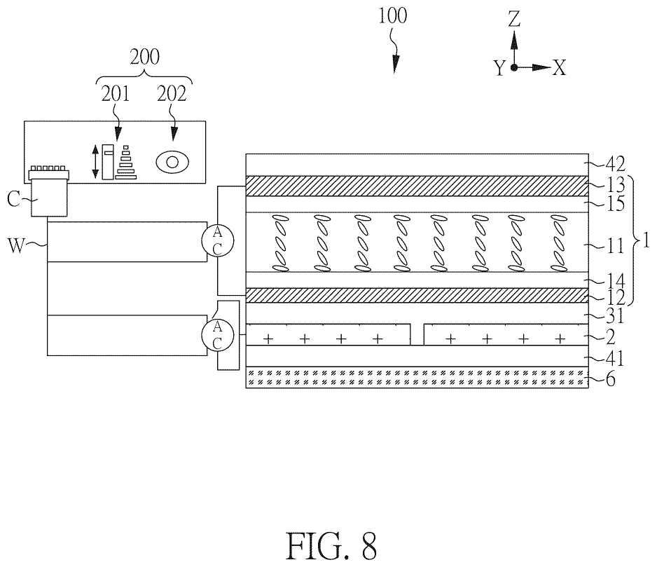

FIG. 8 is a schematic view of an electronic device according to one embodiment of the present disclosure. The electronic device shown in FIG. 8 is similar to that shown in FIG. 1A, except for the following differences.

In one embodiment of the present disclosure, as shown in FIG. 8, the switchable light modulation element 100 may further comprise: a reflective element 6 disposed on the other side of the first substrate 41 away from the second substrate 42. Herein, the light modulation structure 1 is disposed between the first substrate 41 and the second substrate 42. The reflective element 6 may be used to reflect incident light. Thus, in one embodiment of the present disclosure, the electronic device can be applied to reflectors or rear-view mirrors for vehicles, but the present disclosure is not limited thereto.

In one embodiment of the present disclosure, even not shown in the figure, the vibration element 2 shown in FIG. 8 may also comprise the ferromagnetic material 23 and the electromagnet 24 shown in FIG. 3, which are not described again here.

In the present disclosure, the material of the reflective element 6 may, for example, comprise a metal, an alloy thereof or a combination thereof. Suitable metal may be, for example, aluminum, chrome, silver or a combination thereof, but the present disclosure is not limited thereto. In the present disclosure, the light modulation layer 11 in FIG. 8 is exemplified by a highly twisted nematic liquid crystal, but the present disclosure is not limited thereto, other suitable materials may also be used to form the light modulation layer 11. In addition, the other elements and materials of the electronic device may be as described above and will not be described in detail here.

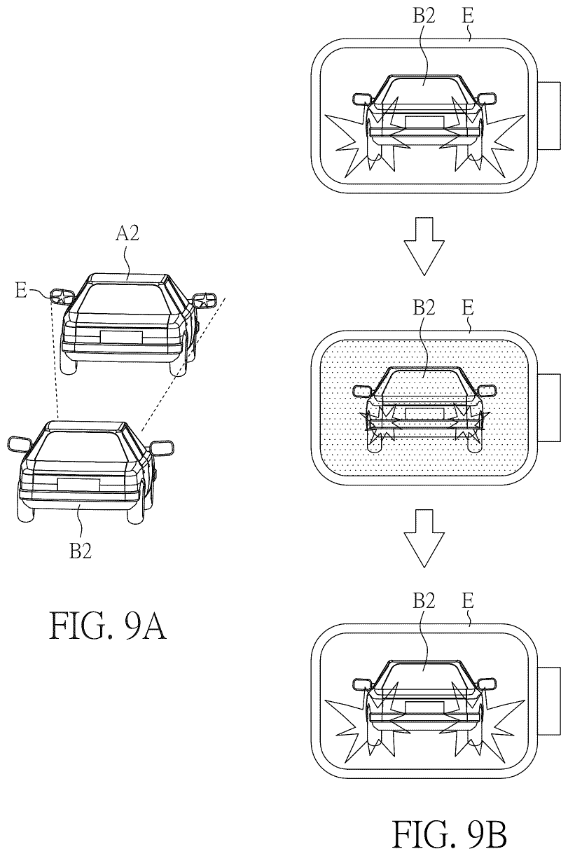

FIG. 9A and FIG. 9B are schematic views of an electronic device according to one embodiment of the present disclosure in operation. The electronic device E of FIG. 9A and FIG. 9B may be any one shown in FIG. 6 to FIG. 8.

In one embodiment of the present disclosure, the electronic device E may be, for example, a rearview mirror for a vehicle, but is not limited thereto. The electronic device E may comprise the switchable light modulation element 100 and the control system 200 shown in any one shown in FIG. 6 to FIG. 8, wherein the light modulation layer 11 may include a dye liquid crystal (including a dye and a liquid crystal material). As shown in FIG. 9A, the headlights of the vehicle B2 coming from behind can be reflected by the vehicle rear-view mirror (that is, the electronic device E) and observed by the driver A2. When the driver A2 observes the vehicle B2 coming from behind through the vehicle rear-view mirror (that is, the electronic device E), the field of vision may be as shown in FIG. 9B.

Please refer to FIG. 6 to FIG. 8, FIG. 9A and FIG. 9B. When no voltage is applied to the light modulation structure 1, the light modulation structure 1 may be, for example, highly transparent. In this case, the light reflectivity of the electronic device E may be, for example, greater than or equal to 75%, 80% or 85%, that is, most of the light can be reflected by the electronic device E. Therefore, the driver A2 can clearly observe the vehicle B2 coming from behind. However, if the headlights of the vehicle B2 coming from behind are too bright, it will easily affect the driving safety of driver A2. When a voltage is applied to the light modulation structure 1, the light transmittance of the light modulation structure 1 decreases. At this time, the light reflectivity of the electronic device E may be, for example, less than or equal to 60%, 55% or 50%, that is, only part of the light can be reflected by the electronic device E. Therefore, the driver A2 is less affected by the headlights of the rear vehicle B2, which can improve driving safety. After removing the voltage applied to the light modulation structure 1, the dye liquid crystal in the light modulation layer 11 gradually returns to the initial state, making the light modulation structure 1 highly transparent. At this time, the light reflectivity of the electronic device E can be restored to, for example, greater than or equal to 75%, 80% or 85%, and the driver A2 can clearly see the vehicle B2 coming from behind again.

In the present disclosure, the vibration element 2 can be driven during the process of applying a voltage to the light modulation structure 1 and removing the voltage from the light modulation structure 1. The vibration element 2 can be used to disturb the light modulation layer 11, thereby increasing the switching speed of the electronic device E and thereby improving driving safety. On the contrary, if the vibration element 2 is not driven during the process of applying voltage to the light modulation structure 1, the switching speed of the electronic device E will be reduced. If the vibration element 2 is not driven during the process of removing the voltage applied to the light modulation structure 1, the dye liquid crystal can only be restored to the initial state by the force of the alignment layer (such as the first alignment layer 14 and/or the second alignment layer 15), which may easily cause the electronic device E to be severely fogged during the switching process, thereby affecting the vision of the driver A2.

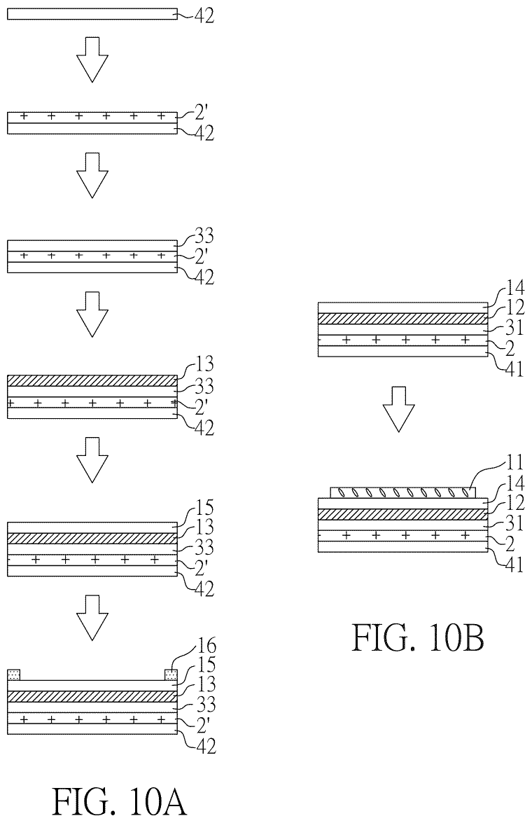

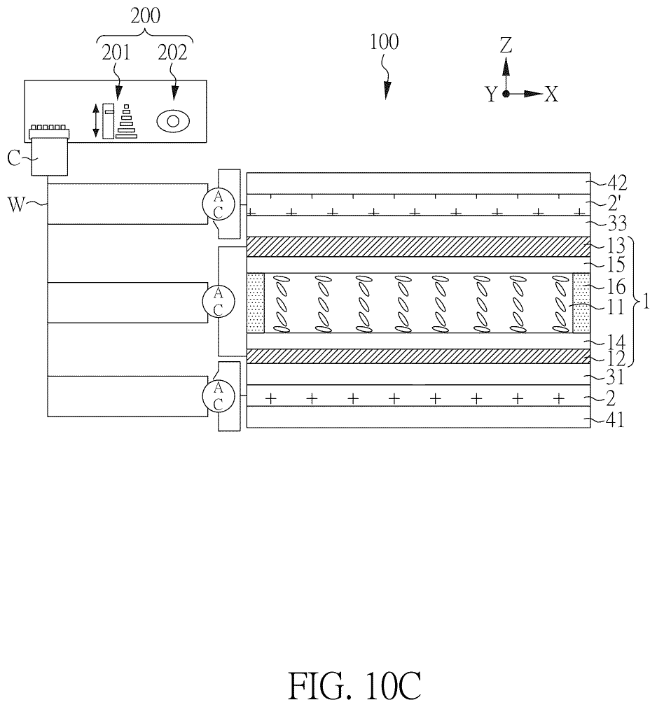

FIG. 10A to FIG. 10C are schematic views showing the manufacture of an electronic device according to one embodiment of the present disclosure.

In one embodiment of the present disclosure, as shown in FIG. 10A, the method for manufacturing the electronic device may comprise: providing a second substrate 42; forming another vibration element 2′ on the second substrate 42; forming an insulating layer 33 on the vibration element 2′; forming a second electrode 13 on the insulating layer 33; forming a second alignment layer 15 on the second electrode 13; and disposing a sealant 16 on the second alignment layer 15. As shown in FIG. 10B, the method for manufacturing the electronic device may comprise: providing a first substrate 41; forming a vibration element 2 on the first substrate 41; forming an insulating layer 31 on the vibration element 2; forming a first electrode 12 on the insulating layer 31; forming a first alignment layer 14 on the first electrode 12; and disposing a light modulation layer 11 on the first alignment layer 14.

Next, the structure shown in FIG. 10A is rotated 180° and paired with the structure shown in FIG. 10B to form a switchable light modulation element 100 of one embodiment of the present disclosure, as shown in FIG. 10C. In the present disclosure, the electronic device shown in FIG. 10C is similar to that shown in FIG. 1A, except for the following differences. In one embodiment of the present disclosure, the switchable light modulation element 100 may comprise: another vibration element 2′ disposed between the second substrate 42 and the second electrode 13; and an insulating layer 33 disposed between the vibration element 2′ and the second electrode 13. The vibration system 202 may be electrically connected to the vibration element 2′ through a conductive wire W to drive the vibration element 2′. In addition, the sealant 16 may be disposed between the first alignment layer 14 and the second alignment layer 15 and surrounds the light modulation layer 11.

In the present disclosure, the material of the sealant 16 may comprise a thermo-curing material, a light-curing material or a thermo-light-curing material, but the present disclosure is not limited thereto. In the present disclosure, the light modulation layer 11 in FIG. 10B and FIG. 10C is exemplified by a highly twisted nematic liquid crystal, but the present disclosure is not limited thereto, the light modulation layer 11 may also be formed by using suspended particles as shown in FIG. 3 or other suitable materials. In the present disclosure, the vibration element 2 and another vibration element 2′ in FIG. 10A to FIG. 10C are exemplified by the entire film, but the present disclosure is not limited thereto, and the vibration element 2 and the other vibration element 2′ may also be patterned films as shown in FIG. 2B or FIG. 2C. In addition, the other components and materials of the electronic device are as described above and will not be described in detail here.

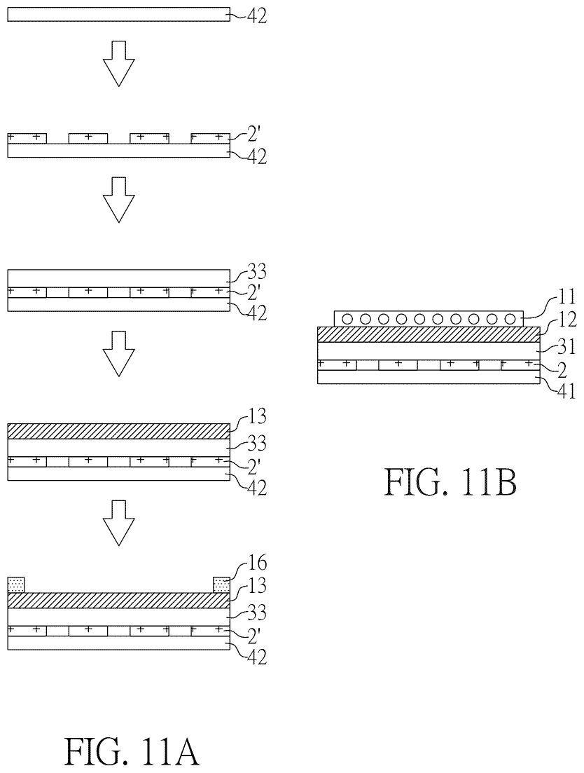

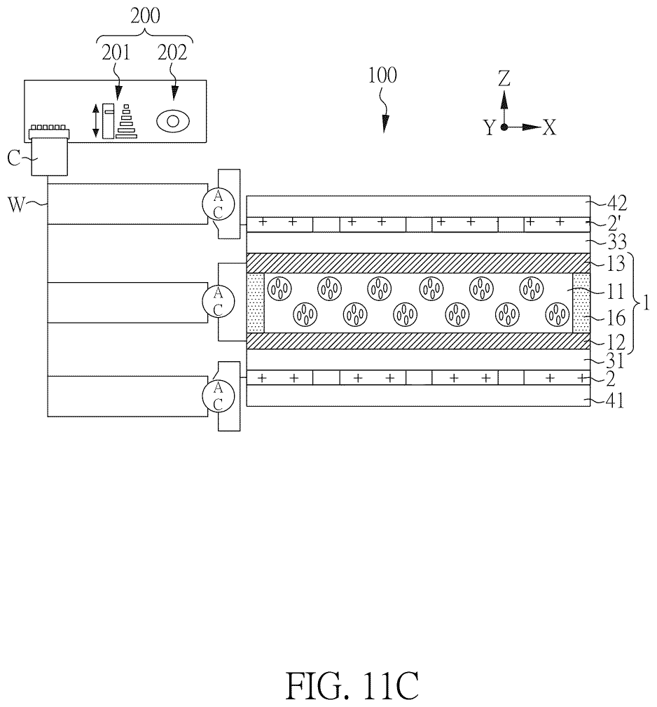

FIG. 11A to FIG. 11C are schematic views showing the manufacture of an electronic device according to one embodiment of the present disclosure.

In one embodiment of the present disclosure, as shown in FIG. 11A, the method for manufacturing the electronic device may comprise: providing a second substrate 42; forming another vibration element 2′ on the second substrate 42, wherein the vibration element 2′ is a patterned film; forming an insulating layer 33 on the vibration element 2′; forming a second electrode 13 on the insulating layer 33; and disposing a sealant 16 on the second electrode 13. As shown in FIG. 11B, the method for manufacturing the electronic device may comprise: providing a first substrate 41; forming a vibration element 2 on the first substrate 41, wherein the vibration element 2 is a patterned film; forming an insulating layer 31 on the vibration element 2; forming a first electrode 12 on the insulating layer 31; and disposing a light modulation layer 11 on the first electrode 12.

Next, the structure shown in FIG. 11A is rotated 180° and paired with the structure shown in FIG. 11B to form the switchable light modulation element 100 of one embodiment of the present disclosure, as shown in FIG. 11C. In the present disclosure, the electronic device shown in FIG. 11C is similar to that shown in FIG. 10C, except for the following differences. In one embodiment of the present disclosure, the light modulation layer 11 in FIG. 11B and FIG. 11C is illustrated by suspended particles, so the first alignment layer 14 (as shown in FIG. 10C) and the second alignment layer 15 (as shown in FIG. 10C) may be omitted, but the present disclosure is not limited thereto. The vibration element 2 and the vibration element 2′ may be patterned films, so the light transmittance of the vibration element 2 and the vibration element 2′ can be improved, but the present disclosure is not limited thereto. The sealant 16 may be disposed between the first electrode 12 and the second electrode 13 and surround the light modulation layer 11. In addition, other components and materials of the electronic device are as described above and will not be described in detail here.

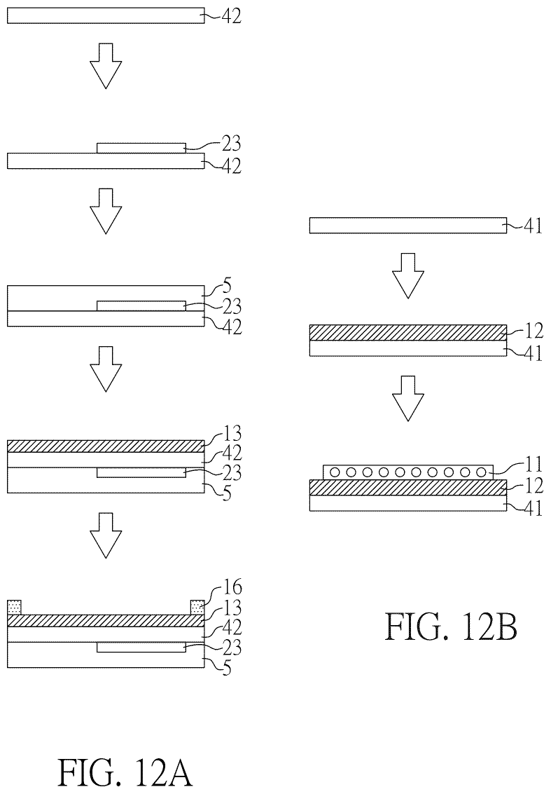

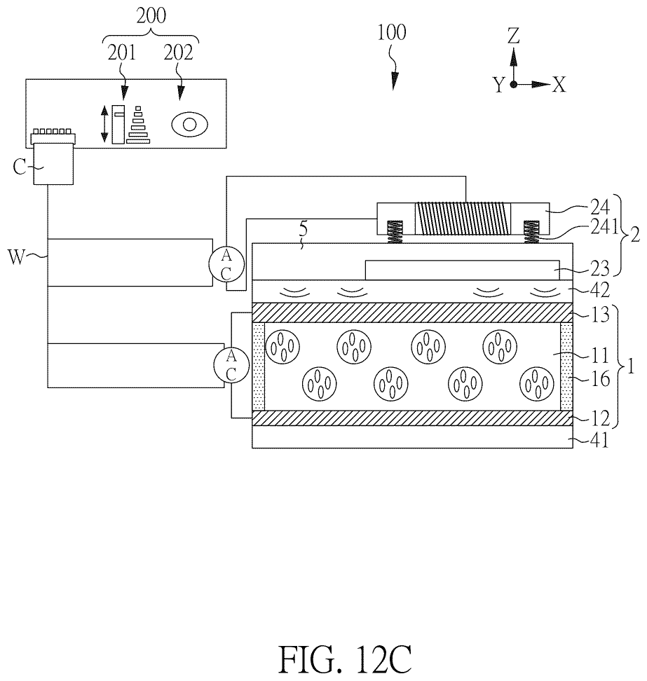

FIG. 12A to FIG. 12C are schematic views showing the manufacture of an electronic device according to one embodiment of the present disclosure.

In one embodiment of the present disclosure, as shown in FIG. 12A, the method for manufacturing the electronic device may comprise: providing a second substrate 42; forming a ferromagnetic material 23 on the second substrate 42; forming a barrier layer 5 on the ferromagnetic material 23; rotating the aforesaid structure 180°to form a second electrode 13 on a side of the second substrate 42 away from the ferromagnetic material 23; and disposing a sealant 16 on the second electrode 13. As shown in FIG. 12B, the method for manufacturing the electronic device may comprise: providing a first substrate 41; forming a first electrode 12 on the first substrate 41; and disposing a light modulation layer 11 on the first electrode 12.

Next, the structure shown in FIG. 12A is rotated 180° and paired with the structure shown in FIG. 12B; and an electromagnet 24 is disposed on the barrier layer 5 to form the switchable light modulation element 100 of one embodiment of the present disclosure, as shown in FIG. 12C. In the present disclosure, the electronic device of FIG. 12C is similar to that shown in FIG. 3, except for the following differences. In one embodiment of the present disclosure, as shown in FIG. 12C, the ferromagnetic material 23 and the electromagnet 24 are disposed on a side of the second substrate 42 away from the light modulation structure 1. In addition, the sealant 16 may be disposed between the first electrode 12 and the second electrode 13 and surround the light modulation layer 11.

In one embodiment of the present disclosure, another vibration element (not shown in the figure) may be selectively included on a side of the first substrate 41 away from the light modulation structure 1, and the vibration element may comprise another ferromagnetic material (not shown in the figure) and another electromagnet (not shown in the figure) or other types of vibration element. When driving another vibration element, the material of the light modulation layer 11 to reach a uniform stable state can be accelerated.

In the present disclosure, the material of the sealant 16 may comprise a thermo-curing material, a light-curing material or a thermo-light-curing material, but the present disclosure is not limited thereto. In the present disclosure, the light modulation layer 11 in FIG. 12B and FIG. 12C is illustrated by suspended particles, but the present disclosure is not limited thereto, and the light modulation layer 11 may also be formed using a liquid crystal material such as shown in FIG. 1A or other suitable materials. In addition, other elements and materials of the electronic device may be as described above and will not be described in detail herein.

The present disclosure provides a vibration element 2 in an electronic device, and drives the vibration element 2 to disturb the light modulation layer 11, thereby accelerating the state transition of the switchable light modulation element 100.

The above specific embodiments should be construed as merely illustrative and not limiting in any way the remainder of the present disclosure.

Although the present disclosure has been explained in relation to its embodiment, it is to be understood that many other possible modifications and variations can be made without departing from the spirit and scope of the disclosure as hereinafter claimed.

1. An electronic device, comprising:
a switchable light modulation element, comprising:
a light modulation structure, comprising a light modulation layer and an electrode for driving the light modulation layer; and
a vibration element disposed adjacent to at least one side of the light modulation structure,
wherein the vibration element is used to disturb the light modulation layer when driven, and the vibration element and the electrode are separated by at least one insulating material to electrically insulate each other.

2. The electronic device of claim 1, wherein the switchable light modulation element further comprises:
a first substrate; and
a second substrate disposed on a side of the first substrate;
wherein the light modulation structure and the vibration element are disposed between the first substrate and the second substrate.

3. The electronic device of claim 2, wherein the vibration element is disposed between the first substrate and the electrode.

4. The electronic device of claim 1, wherein the switchable light modulation element further comprises:
a first substrate; and
a second substrate disposed on a side of the first substrate;
wherein the light modulation structure is disposed between the first substrate and the second substrate, and the vibration element is disposed on a side of one of the first substrate and the second substrate away from the light modulation structure.

5. The electronic device of claim 1, wherein the vibration element comprises at least one piezoelectric material comprising zinc oxide (ZnO), lead zirconate titanate (PZT), aluminum nitride (AlN), lithium niobate (LiNbO₃), barium titanate (BaTiO₃), or a combination thereof.

6. The electronic device of claim 1, wherein the vibration element comprises an electromagnet.

7. The electronic device of claim 6, wherein the electromagnet hits the light modulation structure at a frequency greater than 0 Hz and less than or equal to 1000 Hz.

8. The electronic device of claim 6, wherein the vibration element further comprises a ferromagnetic material, wherein the ferromagnetic material is disposed between the light modulation layer and the electromagnet.

9. The electronic device of claim 8, wherein the ferromagnetic material and the electromagnet are overlapped in a top view direction of the electronic device.

10. The electronic device of claim 8, wherein the ferromagnetic material or the electromagnet is overlapped with a part of the light modulation layer in a top view direction of the electronic device.

11. The electronic device of claim 1, wherein the light modulation layer comprises a dye liquid crystal, an electrochromic material, suspended particles or a combination thereof.

12. The electronic device of claim 1, wherein the vibration element is a patterned film, and an area of the vibration element is less than an area of the switchable light modulation element in a top view direction of the electronic device.

13. The electronic device of claim 12, wherein the vibration element comprises a plurality of holes.

14. The electronic device of claim 1, wherein a material of the electrode comprises a reflective material comprising aluminum, chromium, silver, an alloy thereof, or a combination thereof.

15. The electronic device of claim 1, wherein the switchable light modulation element further comprises:
a first substrate;
a second substrate disposed on a side of the first substrate; and
a reflective element disposed on another side of the first substrate away from the second substrate,
wherein the light modulation structure is disposed between the first substrate and the second substrate.

16. The electronic device of claim 15, wherein the reflective material comprising aluminum, chromium, silver, an alloy thereof, or a combination thereof.

17. The electronic device of claim 1, wherein the switchable light modulation element further comprises:
a first substrate;
a second substrate disposed on a side of the first substrate; and
a reflective element disposed on the side of the first substrate adjacent to the second substrate,
wherein the light modulation structure and the reflective element are disposed between the first substrate and the second substrate, and the light modulation structure is disposed between the second substrate and the reflective element.

18. The electronic device of claim 17, wherein the reflective material comprising aluminum, chromium, silver, an alloy thereof, or a combination thereof.

19. The electronic device of claim 1, wherein the vibration element disturb the light modulation layer at a frequency greater than 0 Hz and less than or equal to 1000 Hz.

20. The electronic device of claim 1, wherein the vibration element comprises a plurality of holes.
